(19) United States
(12) Patent Application Publication
(10) Pub. No.: US 2018/0003817 A1
(43) Pub. Date: Jan. 4, 2018

(54) ULTRASONIC LOCATION SYSTEM

(71) Applicant: Intel Corporation, Santa Clara, CA (US)

(72) Inventors: Jakub Wenus, Maynooth (IE); Niall Cahill, Dublin (IE); Michael Nolan, Maynooth (IE)

(73) Assignee: Intel Corporation, Santa Clara, CA (US)

(21) Appl. No.: 15/198,185

(22) Filed: Jun. 30, 2016

(51) Int. Cl. G01S 15/06

(52) U.S. Cl. CPC G01S 15/06

(57) ABSTRACT

Ultrasonic location systems are provided. These ultrasonic location systems include two or more wave transmitters, two or more wave receivers, and a mapping component that controls the operation of the transmitters and the receivers. The mapping component relies on collaborative operation of multiple transmitters and multiple phased-array receivers where each of the transmitters emits a short burst of sound wave in a pre-defined sequence and after every burst all phased-array receivers detect the wave reflected from surrounding objects. The mapping component uses the position of the transmitters, the position of the receivers, the time of transmission, the time of reception, and the phase shift of the waves to calculate a time of flight and a direction of arrival for the reflections. The mapping component uses triangulation to determine a distance between any physical objects acting as sources of reflection and one or more physical objects having a recorded position relative to the receivers.

### BACKGROUND

Typical proximity detectors are composed of highly directional transducers operating independently from each other. For example, in an ultrasonic rear parking assist system (PSA), several transducers are mounted on the rear bumper of a vehicle in such a way that their ultrasound emission beams overlap only slightly. When the vehicle is reversing, the PSA measures the time it takes for ultrasound to travel from a transducer to an obstacle and back. This Time-of-Flight measurement is then converted into a linear measurement of the distance between the vehicle and the obstacle. Thus the PSA can only roughly detect the proximity of the obstacle and cannot detect the three-dimensional position of the obstacle relative to the vehicle. In addition, PSA's typically have dead detection points at the boundaries between adjacent ultrasound beams. Electromagnetic parking system's (EPS's) are generally free from these dead points, however, EPS's still cannot resolve 3D positions of obstacles. Also, an EPS's can only detect objects when the vehicle is in motion.

### BRIEF DESCRIPTION OF THE DRAWINGS

FIG. 1 is a schematic diagram of an ultrasonic location system in accordance with certain embodiments of the present disclosure.

FIG. 2 is a flow diagram of a mapping process in accordance with certain embodiments of the present disclosure.

FIG. 3 is a schematic diagram of a sensor array included in an ultrasonic location system in accordance with certain embodiments of the present disclosure.

FIG. 4 is another schematic diagram of a sensor array included in an ultrasonic location system in accordance with certain embodiments of the present disclosure.

FIG. 5 is another schematic diagram of a sensor array included in an ultrasonic location system in accordance with certain embodiments of the present disclosure.

FIG. 6 is another schematic diagram of a sensor array included in an ultrasonic location system in accordance with certain embodiments of the present disclosure.

FIG. 7 is a schematic diagram of vehicle including an ultrasonic location system in accordance with certain embodiments of the present disclosure.

FIG. 8 is a schematic diagram illustrating a variety of phased-array receivers in accordance with certain embodiments of the present disclosure.

Although the following Detailed Description will proceed with reference being made to illustrative embodiments, many alternatives, modifications, and variations thereof will be apparent in light of this disclosure.

### DETAILED DESCRIPTION

Ultrasonic location systems disclosed herein map positions of physical objects with greater accuracy than conventional proximity detectors. In some embodiments, an ultrasonic location system includes two or more wide-angle sound wave transmitters (e.g., audio speakers, ultrasonic emitters, transducers, etc.), two or more sound wave receivers (e.g., microphones, ultrasonic receivers, sensors, transducers, etc.), and a mapping component that is connected to and controls the operation of the transmitters and the receivers. The receivers are arranged in a phased-array configuration (e.g., two or more of microphones arranged in a pre-defined pattern) to enable phase-shift detection in reflected waves. In these embodiments, the mapping component initiates collaborative operation of multiple wide-angle transmitters and multiple receivers arranged in one or more phased-arrays. The acts executed within this collaborative operation include the transmitters emitting short bursts of sound (e.g., ultrasound) waves in a predefined sequence and, after every burst, all phased-array receivers detecting any waves reflected from surrounding objects. The mapping component uses the position of the transmitters, the position of the receivers of the reflections, the time of transmission of the waves, the time of detection of the reflections, and the phase shift recorded by the one or more phased-arrays to calculate a time of flight (ToF) and a direction of arrival (DoA) for the reflections. Further, the mapping component uses triangulation to determine a distance between any physical objects acting as sources of reflection and one or more physical objects having a recorded position relative to the receivers (e.g., the bumper of a vehicle to which the receivers are affixed).

Examples of the methods and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements and features discussed in connection with any one or more examples are not intended to be excluded from a similar role in any other examples.

Also, the phraseology and terminology used herein is for the purpose of description and should not be regarded as limiting. Any references to examples, embodiments, components, elements or acts of the systems and methods herein referred to in the singular may also embrace embodiments including a plurality, and any references in plural to any embodiment, component, element or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms. In addition, in the event of inconsistent usages of terms between this document and documents incorporated herein by reference, the term usage in the incorporated references is supplementary to that of this document; for irreconcilable inconsistencies, the term usage in this document controls.

General Overview

As previously explained, conventional proximity detectors fail to determine locations of objects with the accuracy and precision required for some applications. Thus, and in accordance with some embodiments of the present disclosure, ultrasonic location systems are provided that utilize a phased sensor array to measure the ToF and DoA of waves reflected from an object and use these measurements to accurately and precisely define the position of the object via triangulation. Instead of a set of ultrasonic transducers as in a conventional PSA, some embodiments described herein employ a set of wide-angle transmitters of ultrasound in conjunction with phased-array receivers composed of multiple ultrasonic microphones. The wide-angle ultrasonic transmitters may transmit waves with overlapping areas for avoiding “dead points,” which are a common problem with conventional PSAs. In some embodiments, Each of the transmitters emits a short burst of ultrasonic waves in sequence (e.g., one at a time). After every burst, all phased-array receivers detect waves reflected from surrounding objects. Because of the phased-array configuration of the receivers, they are capable of detecting both the time delay and the phase shift of the incoming signal. The time delay between sending the ultrasound burst and receiving its reflected echo (ToF) is proportional to the distance from the object. Additionally, the phase shift detected by the phased-array carries information about the angle of arrival of the reflected signal (DoA). When the ToF and the DoA signals are recorded on all receivers after each emitted burst, some embodiments disclosed herein further apply triangulation to fine-tune the results which can then be used to create a simple 3D map of the surrounding space. These and other aspects of ultrasonic location systems are described further below. The embodiments disclosed herein are suitable for vehicle parking applications, autonomous navigation of robots, and driver-less vehicles, among other areas.

Ultrasonic Location System

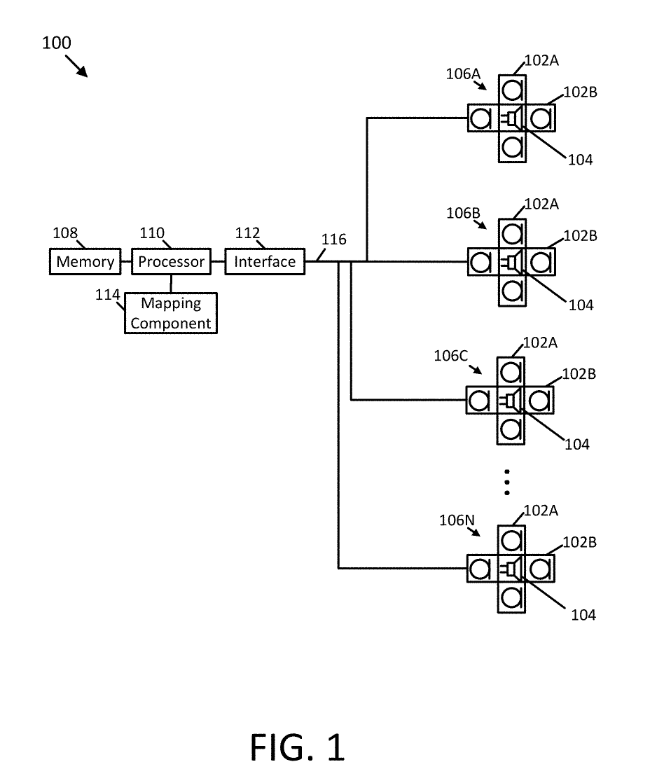

FIG. 1 illustrates one example of an ultrasonic location system 100. As shown, the ultrasonic location system 100 includes transceivers 106A, 106B, 106C, and 106N, a memory 108, at least one processor 110, an interface 112, a mapping component 114, and a connector 116. As shown in FIG. 1, the memory 108, the interface 112, the processor 110, and, in some embodiments, the mapping component 114 are coupled with one another via an interconnection mechanism, which is illustrated by lines connecting these component. The interconnection mechanism may be as a bus or some other data connection.

Each of the transceivers 106A, 106B, 106C, and 106N includes at least one transmitter (e.g., a speaker 104) and at least two receivers (e.g., two pairs of microphones 102A and 102B). As shown in FIG. 1, a longitudinal axis formed by the pair of microphones 102A is perpendicular to a longitudinal axis formed by the pair of microphones 102B. Each of the transceivers 106A, 106B, 106C, and 106N is coupled to the interface 112 via a connector 116. The connector 116 may be wired or wireless. In some examples, both the transceivers 106A, 106B, 106C, and 106N and the interface 112 are configured to exchange signals via the connector 116. For example, the transceivers 106A, 106B, 106C, and 106N, the interface 112, and the connector 116 may all support communication via a serial protocol.

In some embodiments, the signals exchanged via the connector 116 communicate a variety of data and commands. Examples of commands that may be communicated include commands from the interface 112 to one or more of the transceivers 106A, 106B, 106C, and 106N. In some embodiments, these commands include commands for a speaker 104 to transmit a wave burst and commands for microphones included in the pairs 102A and 102B to monitor for reflected waves. Examples of data that may be exchanged between the transceivers 106A, 106B, 106C, and 106N and the interface 112 include data from the interface 112 to configure one or more of the transceivers 106A, 106B, 106C, and 106N and data from one or more of the transceivers 106A, 106B, 106C, and 106N to the interface 112. This data from one or more of the transceivers 106A, 106B, 106C, and 106N to the interface 112 may include data identifying one of speakers 104 and a time when the speaker 104 transmitted a wave burst and data including an identifier of a microphone from one of the pairs of microphones 102A and 102B, a time when the microphone detected a reflected wave, and the phase of the reflected wave.

Although FIG. 1 illustrates 4 transceivers, embodiments disclosed herein are not limited to any particular number of transceivers, speakers or receivers. As shown in FIG. 1, it is appreciated that some number of intervening transceivers may be disposed between 106C and 106N, in some embodiments.

The interface 112 includes one or more physical interface ports that may include input connectors, output connectors, and combination input/output connectors and software configured to drive operation of the ports and connectors. The interface 112 may receive input or provide output. The interface 112 allows other components of ultrasonic location system 100 to exchange information and communicate with the transceivers 106A, 106B, 106C, and 106N. In some examples illustrated by FIG. 1, the ports included in the interface 112 include at a USB port or some other port used to communicate information using a serial protocol.

In some embodiments, the processor 110 executes a series of instructions (i.e., one or more programs) that result in manipulated data. The processor 110 may be any type of processor, multiprocessor, microprocessor, or controller known in the art. The processor 110 is connected to and communicates data with the memory 108 and the interface 112. In operation, the processor 110 causes data to be read from a non-volatile (i.e., non-transitory) data storage medium in the memory 108 and written to high performance data storage. The processor 108 manipulates the data within the high performance data storage and copies the manipulated data to the data storage medium after processing is completed.

The memory 108 includes readable and/or writeable data storage that stores programs and data used or manipulated during operation of the ultrasonic location system 100. The programs stored in the memory 108 are a series of instructions that are executable by the processor 110. The memory 108 may include relatively high performance data storage, such as registers, caches, dynamic random access memory, and static memory. The memory 108 may further include a relatively low performance, non-volatile data storage medium such as flash memory or an optical or magnetic disk. Various embodiments may organize the memory 108 into particularized and, in some cases, unique structures to store data in support of the components disclosed herein. These data structures may be specifically configured to conserve storage space or increase data exchange performance and may be sized and organized to store values for particular types of data.

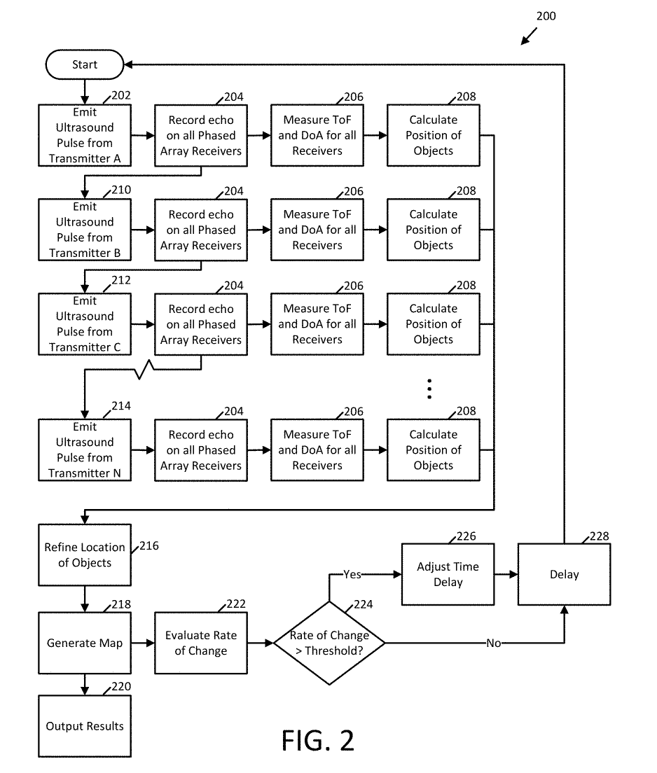

In some examples, the mapping component 114, which may be implemented as a hardware component and/or as a software component, is configured to execute one or more mapping processes using the transceivers 106A, 106B, 106C, and 106N. FIG. 2 illustrates one example of a mapping process 200 in accord with some embodiments. This mapping process 200 is described below with combined reference to FIGS. 2-5.

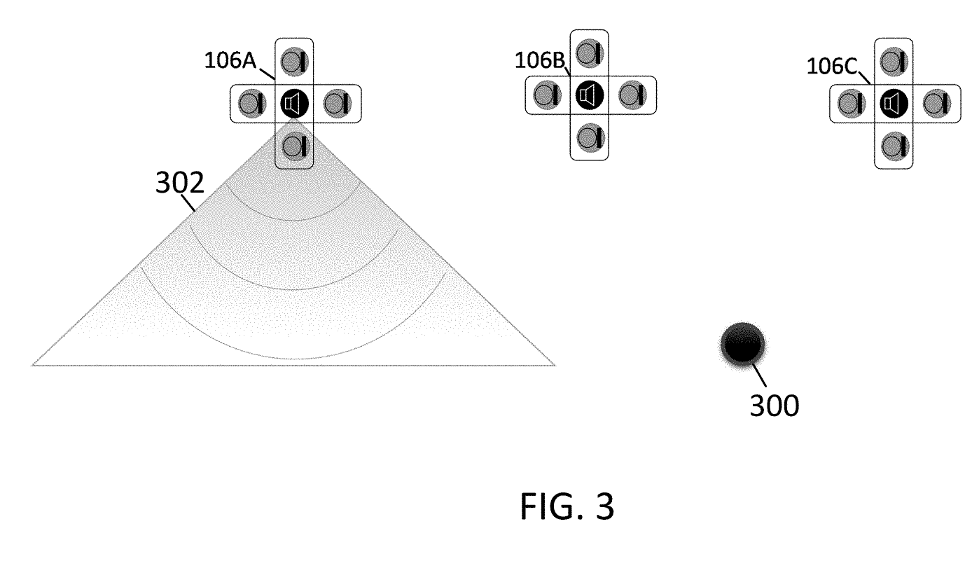

The mapping process 200 starts with act 202 in which a mapping component (e.g., the mapping component 114) controls a first transceiver (e.g., the transceiver 106A) to transmit a wave burst 302. This act is illustrated in FIG. 3, which shows the transceiver 106A transmitting the wave burst 302. In act 204, all receivers in the phased-array listen for, record, and transmit data descriptive of any reflected waves they encounter. This data may include an identifier of the receiver, the time of reception of the reflected wave, and the phase of the reflected wave. As depicted in FIG. 3, the wave burst 302 does not encounter the object 300 and therefore no reflected waves are encountered by any of the transceivers 106A, 106B, or 106C. In act 206, the mapping component calculates measures for the ToF and DoA using the data transmitted by the receivers and the positions of the receivers. In some embodiments, the arrangement of the microphones in a two-dimensional array to two perpendicular one-dimensional linear arrays (two perpendicular microphone pairs 102A and 102B in the simplest case) increases the accuracy of the DoA measurement because of the additional phase shift information each array can provide. The accuracy of the phase-shift measurement is directly related to the receivers in the array. Thus, to increase the accuracy of the phase-shift measurement, some embodiments include receivers arranged in a 4×4 phased-array and other embodiments include receivers arranged in an 8×8 phased-array.

However, because the wave burst 302 is not reflected according to FIG. 3, the mapping component has no data to process in the act 206 in the example illustrated by FIG. 3. In act 208, the mapping component calculates one or more positions of one or more objects using triangulation. Again, because the wave burst 302 is not reflected according to FIG. 3, the mapping component has no data to process in the act 208 in the example illustrated by FIG. 3.

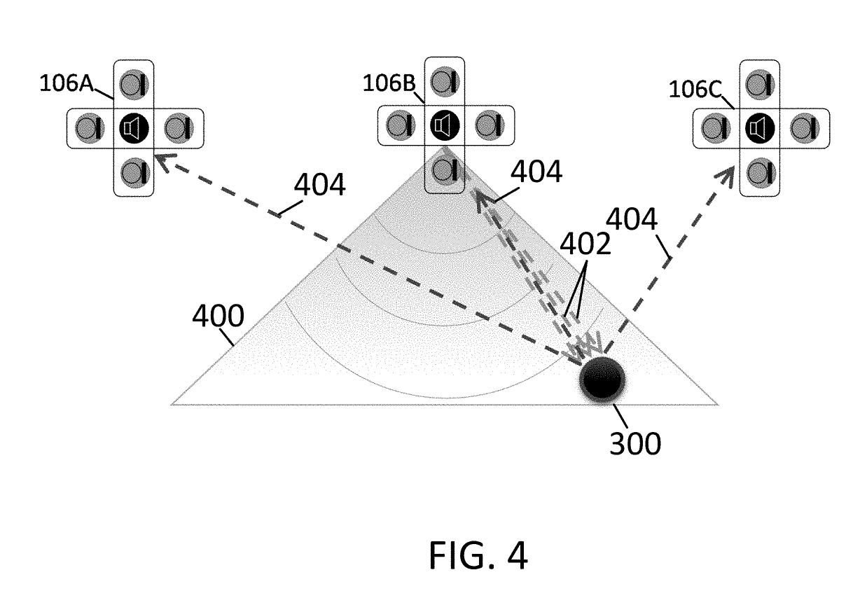

In act 210 the mapping component controls a second transceiver (e.g., the transceiver 106B) to transmit a wave burst 400. This act is illustrated in FIG. 4, which shows the transceiver 106B transmitting the wave burst 400. In act 204, all receivers in the phased-array listen for, record, and transmit data descriptive of any reflected waves they encounter. This act is also illustrated in FIG. 4. As depicted in FIG. 4, the wave burst 400 (specifically portions 402) encounter the object 300 and are reflected as reflected waves 404. The reflected waves 404 encounter the transceivers 106A, 106B, and 106C and are detected by one or more microphones included therein. As shown in FIG. 4, the transceivers 106A, 106B, and 106C execute the act 204 by listening for the reflected waves 404, recording reception of the reflected waves 404, and transmitting data identifying themselves and descriptive of the reflected waves to the mapping component via an interface (e.g., the interface 112). In act 206, the mapping component calculates measures for the ToF and DoA using the data transmitted by the receivers and the positions of the receivers. Because the reflected waves 404 encounter the transceivers 106A, 106B, and 106C in FIG. 4, the mapping component executes the act 206 by calculating ToF and DoA measures based on the data returned by the transceivers 106A, 106B, and 106C via an interface. In act 208, the mapping component 208 calculates one or more positions of one or more objects using triangulation. Again, because the reflected waves 404 encounter the transceivers 106A, 106B, and 106C in FIG. 4, the mapping component executes the act 208 to calculate the position of the object 300 based on the data returned by the transceivers 106A, 106B, and 106C via the interface.

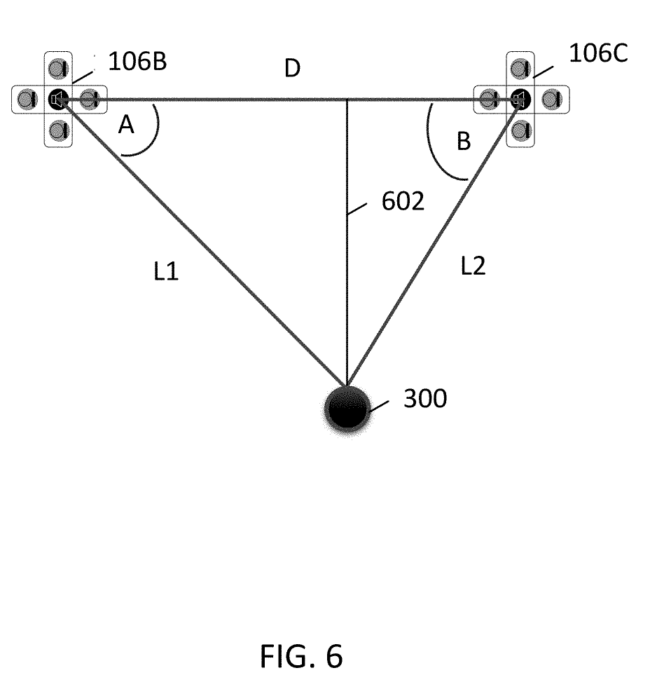

In some embodiments, the mapping component calculates, in the act 208, the position of an object using triangulation. FIG. 6 illustrates one example of triangulation in accordance with some examples. As shown in FIG. 6 with continued reference to FIGS. 2 and 4, angle A is the DoA, as calculated by the mapping component in the act 206, for the reflected wave 404 encountered by the transceiver 106B. Similarly, the angle B is the DoA, as calculated by the mapping component in the act 206, for the reflected wave 404 encountered by the transceiver 106C.

Also as shown in FIG. 6, the mapping component calculates the distance L1 based on the ToF of the portions of the wave burst 402 and the reflected wave 404 encountered by the transceiver 106A. Similarly, the mapping component calculates the distance L2 based on the ToF of the potions of the wave burst 402 and the reflected wave 404 encountered by the transceiver 106B. In addition, the mapping component may calculate the distance of L2+L1 based on the ToF of a wave burst originating at the transceiver 106B and having a reflected wave encountered by the transceiver 106A. Similarly, the mapping component may calculate the distance of L1+L2 based on the ToF of a wave burst originating at the transceiver 106A and having a reflected wave encountered by the transceiver 106B. The distance D between the transmitters of the transceivers 106A and 106B is stored in a memory (e.g., the memory 108) and is accessible to the mapping component. In some embodiments, the mapping component calculates the distance 602 using some combination of L1, L2, A, and/or B. For example, In at least one embodiment, the mapping component calculates the distance 602 within the act 208 using the following equation distance 602=D*sin(A)sin(B)/sin(A+B).

In some embodiments, in the act 208, the mapping component calculates the distance 602 by calculating multiple measurements of the distance 602 using multiple combinations of L1, L2, A, and/or B and by analyzing the multiple distance measurements to identify the distance 602 with greater accuracy. For instance, in one example, the mapping component determines the mean and/or the mode of the multiple distance measurements and records the mean or the mode as the distance 602. In another example, the mapping component resolves differences in the calculated distances in favor of distances calculated using particular combinations of L1, L2, A, and B. For instance, the mapping component may favor a distance determined using L1 and L2 over a distance determined using L1 or L2 and A or B, and the mapping component may favor a distance determined using L1 or L2 and A or B over a distance calculated using A and B. In another example, where one or more of L1, L2, A, and B measurements is not available or suspect (e.g., due a noisy environment), the mapping component may calculate the distance 602 using the available or reliable measurements.

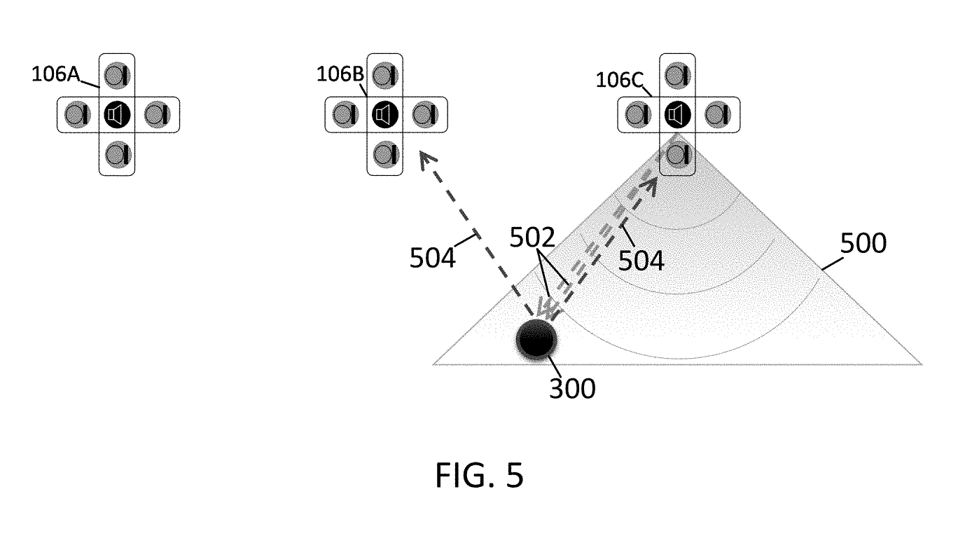

Returning to the mapping process 200 illustrated in FIG. 2, in act 212 the mapping component controls a third transceiver (e.g., the transceiver 106C) to transmit a wave burst 500. This act is illustrated in FIG. 5, which shows the transceiver 106B transmitting the wave burst 500. In act 204, all receivers in the phased-array listen for, record, and transmit data descriptive of any reflected waves they encounter. This act is also illustrated in FIG. 5. As depicted in FIG. 5, the wave burst 500 (specifically portions 502) encounter the object 300 and are reflected as reflected waves 504. The reflected waves 504 encounter the transceivers 106A and 106C and are detected by one or more microphones included therein. As shown in FIG. 5, the transceivers 106A and 106C execute the act 204 by listening for the reflected waves 504, recording reception of the reflected waves 504, and transmitting data identifying themselves and describing the reflected waves 504 to the mapping component via the interface. In act 206, the mapping component calculates measures for the ToF and DoA using the data transmitted by the receivers and the positions of the receivers. Because the reflected waves 504 encounter the transceivers 106A and 106C in FIG. 5, the mapping component executes the act 206 by calculating ToF and DoA measures based on the data returned by the transceivers 106A and 106C via an interface. In act 208, the mapping component 208 calculates one or more positions of one or more objects using triangulation. Again, because the reflected waves 504 encounter the transceivers 106A and 106C in FIG. 5, the mapping component executes the act 208 to calculate the position of the object 300 based on the data returned by the transceivers 106A and 106C via the interface.

In act 214 the mapping component controls another transceiver to transmit a wave burst. And the acts 204, 206, and 208 are repeated. These actions may be repeated for each transceiver included in the ultrasonic location system.

In the act 216, the mapping component refines the measured position of various objects by analyzing the data processed in each interaction of the act 208. For instance, in some embodiments the mapping component averages various measurements to generate a refined position measurement. For instance, to compensate for omitted measurements or measurements rendered unreliable by noisy, the mapping component may record a measurement based on multiple measurements of the same physical parameter. For example, with combined reference to FIGS. 4-6, let L1 in FIG. 6 be the distance from the transceiver 106B to the object 300 and let L2 be the distance from the transceiver 106C to the object 300. In the act 206, as illustrated in FIG. 4, the mapping component calculates L1 and L1+L2. In the act 206, as illustrated in FIG. 5, the mapping component calculates L2 and L2+L1. In the act 216, the mapping component refines these measurements by, for example, comparing the L1+L2 generated during both actions and averaging and/or verifying reliability of the results. Additionally, in some embodiments, the mapping component calculates L1 where L1 was not directly measured by subtracting L2 from (L1+L2). In other embodiments, in the act 216 the mapping component refines one or more of the measurements disclosed herein using the techniques described above with reference to the act 208 (i.e., calculating the mean and/or mode of the measurements, favoring one source (e.g., transceiver and/or contributing factors) of a measurement over another, and/or a combination of the above).

In act 218, the mapping component generates a map of including all of the detected objects. In some embodiments, the map is stored in a two-dimensional array of values that represents proximity of objects detected within a field of view. In these embodiments, the first dimension (X-axis) of the array represents a horizontal angle (azimuth), the second dimension (Y-axis) represents a vertical angle (elevation), and the values represent the distance from the nearest object in each direction. This two-dimensional array may be considered to be a depth map representing surrounding objects which are within the field of view and which are within the detecting range of the system, which is from a few centimeters to approximately 2 meters in some embodiments.

In act 220, the mapping component outputs information descriptive of the map generated in the act 218. For example, the mapping component may transmit the map to a vehicle navigation system to enable the navigation system to warn a driver of the proximity of obstacles during parking and/or during driving.

In act 222, the mapping component evaluates the amount of change in the map generated in the act 218. For instance, in one embodiment, within the act 222 the mapping component calculates a metric indicative of the rate of change of objects' positions in the map. In act 224, the mapping component compares the amount of change (e.g., the rate of change) to a threshold. Where the amount of change transgresses the threshold (e.g., 1 meter/second), the mapping component executes act 226. In some embodiments, threshold compared to in the act 224 varies over time and bears a direct relationship with the last recorded distance to an object. If the amount of change does not transgress the threshold, the mapping component executes the act 228.

In the act 226, the mapping component adjusts a delay time (e.g., approximately 0.1-10 milliseconds) between map revisions (e.g., a time delay before returning to the act 202 and proceeding). Where the amount of change transgresses a threshold that indicates the amount of change is small, the mapping component increases the delay time within the act 226. Where the amount of change transgresses a threshold that indicates the amount of change is large, the mapping component increases the delay time within the act 226. In the act 228, the mapping component suspends execution of the mapping process 200 for an amount of time indicated by the delay time.

In some embodiments, mapping component is implemented using ASICs. In other embodiments, mapping component is implemented by the processor 110. As described above, this processor 110 may be general purpose processor. However, when executing a specific software process as described herein (e.g., as depicted in FIG. 2), the processor 110 becomes a special purpose processor capable of making specific logic-based determinations based on input data received, and further capable of providing one or more outputs that can be used to control or otherwise inform subsequent processing to be carried out by the processor 110 and/or other processors or circuitry with which processor 110 is communicatively coupled. The processor 110 reacts to specific input stimulus in a specific way and generates a corresponding output based on that input stimulus. In this sense, the structure of processor 110 according to one embodiment is defined by the flow chart shown in FIG. 2. Moreover, in some example cases, the processor 110 proceeds through a sequence of logical transitions in which various internal register states and/or other bit cell states internal or external to the processor may be set to logic high or logic low. This specific sequence of logic transitions is determined by the state of electrical input signals to the processor 110 and a special-purpose structure is effectively assumed by the processor 110 when executing each software instruction of the software processes shown in FIG. 2. Specifically, those instructions anticipate the various stimulus to be received and change the implicated memory states accordingly. In this way, the processor 110 may generate and store or otherwise provide useful output signals. Thus, it is appreciated that the processor 110, during execution of a software process becomes a special purpose machine, capable of processing only specific input signals and rendering specific output signals based on the one or more logic operations performed during execution of each software instruction. In at least some examples, the processor 110 is configured to execute a function where software is stored in a data store coupled with the processor 110 (e.g., the memory 108) and that software is configured to cause the processor 110 to proceed through a sequence of various logic operations that result in the function being executed.

The embodiments disclosed herein are not limited to the ultrasonic location system 100 illustrated in FIG. 1. Indeed, various embodiments may have architectures and/or components different from those shown in FIG. 1. For instance, some examples of an ultrasonic location system may include transceivers having a different number of transmitters and/or receivers arranged differently from the transceivers illustrated in FIG. 1. Other examples of the ultrasonic location system may not utilize transceivers at all, but instead may utilize distinct transmitters and receivers. Further some examples of an ultrasonic location system may transmit waves at frequencies other than ultrasonic frequencies. Still other examples of the ultrasonic location system may transmit and receive wide beam electromagnetic radiation in place of, or in addition to, ultrasound. In addition various components of an ultrasonic location system may include specially programmed, special-purpose hardware, such as an application-specific integrated circuit (ASIC), a field-programmable gate array (FPGA), a complex programmable logic device (CPLD), and other implementations in silicon or other hardware tailored to execute processes disclosed herein. Thus, components of an ultrasonic location system as disclosed herein may be implemented in software, hardware, firmware, or any combination thereof.

Each of the processes disclosed herein depict one particular sequence of acts in a particular example. The acts included in these processes may be performed by, or using, one or more computer systems specially configured as discussed herein. Some acts are optional and, as such, may be omitted in accord with one or more examples. Additionally, the order of acts can be altered, or other acts can be added, without departing from the scope of the systems and methods discussed herein. Furthermore, as discussed above, in at least one example, the acts are performed on a particular, specially configured machine, namely an fidelity management system, a training system, or a testing system configured according to the examples and embodiments disclosed herein.

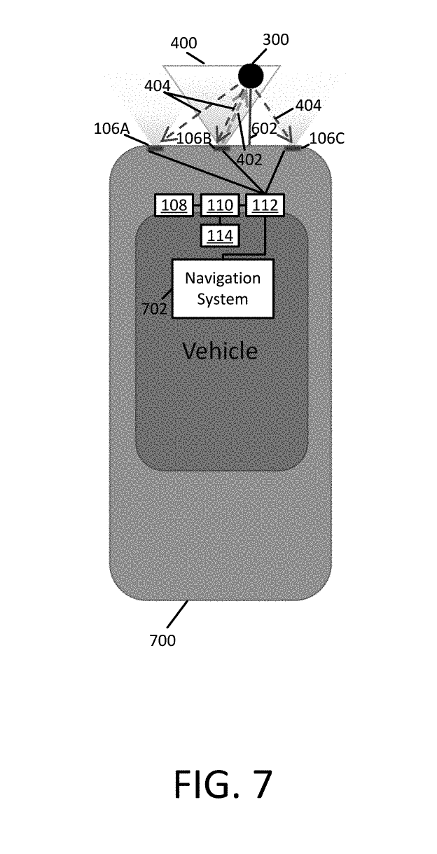

The ultrasonic location system 100 has many potentially useful applications. For example, FIG. 7 illustrates a vehicle 700 including a navigation system 702 and one example of the ultrasonic location system 100. As shown, the transceivers 106A, 106B, and 106C are housed in a bumper of the vehicle. In accordance with the embodiments disclosed herein, the mapping component 114 commands the transceiver 106B to transmit the wave 400. The wave 400 encounters the object 300, and more particularly, the portion of the wave 402 strikes the object and generates reflected saves 404. The reflected waves 404 encounter the transceivers 106A, 106B, and 106C. The transceivers 106A, 106B, and 106C transmit data descriptive of their identity and the reflected waves 404 to the mapping component via the interface 112. The mapping component calculates the ToF portions of the wave 402 and the reflected waves 404 and the DoA of the reflected waves 404 and uses these measurements to determine the distance 602. The mapping component updates a map and provides data descriptive of the map to the navigation system 702. The navigation system 702 use the map to indicate the proximity of the bumper of the vehicle to the object 300 (e.g., via audio, visual, or tactile stimulus to the driver) and/or to control the operation of the vehicle 700 to avoid a collision between the vehicle 700 and the object 300 (e.g., where the vehicle 700 is driverless).

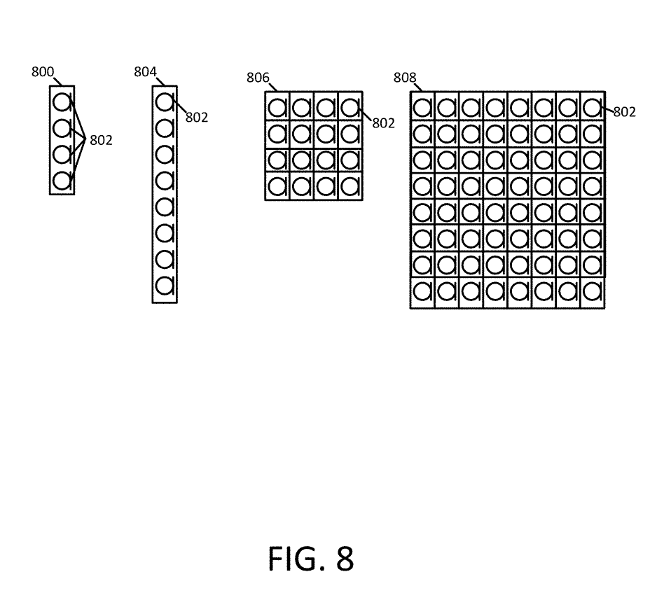

FIG. 8 illustrates a variety of example phased-array receivers in accordance with various embodiments. FIG. 8 includes phased-arrays 800, 804, 806, and 808. The phased-array 800 includes 4 receivers 802 (e.g., microphones) arranged linearly. The phased-array 804 includes 8 receives 802 arranged linearly. The phased-array 806 includes 16 receivers 802 arranged in a 4×4 matrix. The phased-array 808 includes 64 receivers 802 arranged in an 8×8 matrix. In other embodiments, the numbers of receivers included in a phased-array may vary and the shape in which they are configured may also vary. Thus, the embodiments disclosed herein are not limited to the phased-arrays shown in FIG. 8.

### Further Example Embodiments

The following examples pertain to further embodiments, from which numerous permutations and configurations will be apparent.

Example 1 is an ultrasonic location system comprising: a plurality of wave transmitters; a plurality of wave receivers; and at least one processor coupled to the plurality of wave transmitters and the plurality of wave receivers and configured to control each wave transmitter of the plurality of wave transmitters sequentially to transmit at least one wave, to receive data descriptive of at least one reflection of the at least one wave, to calculate at least one direction of arrival (DoA) of the at least one reflection based on the data descriptive of the at least one reflection, and to calculate at least one time of flight (ToF) of the at least one wave and the at least one reflection based on the data descriptive of the at least one reflection and data descriptive of the at least one wave.

Example 2 includes the subject matter of Example 1, wherein each transmitter of the plurality of transmitters is configured to transmit, to the at least one processor, data descriptive of any wave the transmitter transmits.

Example 3 includes the subject matter of Example 1 or 2, wherein the plurality of wave receivers is arranged in a phased-array configuration.

Example 4 includes the subject matter of Example 3, wherein the phased-array configuration is linear and includes at least one of four receivers and eight receivers.

Example 5 includes the subject matter of Example 3 or 4, wherein the phased-array configuration is two-dimensional and includes at least one of a 4×4 receiver configuration and an 8×8 receiver configuration.

Example 6 includes the subject matter of any of Examples 1 through 5, wherein two or more wave receivers of the plurality of wave receivers form an axis that is perpendicular to an axis formed by two or more other wave receivers of the plurality of wave receivers.

Example 7 includes the subject matter of any of Examples 1 through 6, wherein the at least one controller is further configured to control the plurality of wave receivers to monitor for the at least one wave transmitted by each wave transmitter.

Example 8 includes the subject matter of Example 7, wherein each receiver of the plurality of receivers is configured to transmit, to the at least one processor, data descriptive of any reflection received by the receiver.

Example 9 includes the subject matter of any of Examples 1 through 8, wherein the plurality of wave receivers and the plurality of wave transmitters are arranged into a plurality of wave transceivers.

Example 10 includes the subject matter of any of Examples 1 through 9, wherein the at least one processor is further configured to control each wave transmitter of the plurality of wave transmitters to individually transmit at least one wave according to predefined sequence.

Example 11 includes the subject matter of any of Examples 1 through 10, wherein at least one processor is further configured to calculate at least one distance of an object using the at least one DoA and the at least one ToF.

Example 12 includes the subject matter of Example 11, wherein the at least one processor is configured to calculate the at least one distance at least in part by calculating a plurality of measurements and processing the plurality of measurements to determine the at least one distance.

Example 13 includes the subject matter of Example 11 or 12, wherein the at least one processor is further configured to refine the at least one distance using a measurement calculated from data descriptive of at least one wave other than the at least one wave and the at least one reflection.

Example 14 includes the subject matter of any of Examples 11 through 13, further comprising an interface coupled to a navigation system, wherein the at least processor is further configured to transmit data descriptive of the at least one distance to the navigation system via the interface.

Example 15 includes the subject matter of any of Examples 1 through 14, wherein the at least one processor is further configured to control the plurality of wave transmitters to delay for a period of time between consecutive wave transmissions.

Example 16 includes the subject matter of Example 15, wherein the at least one processor is further configured to calculate an amount of change between the at least one distance and the at least one other distance, to compare the amount of change to a threshold, and to adjust the period of time in response to the amount of change transgressing the threshold.

Example 17 is a method of locating objects using an ultrasonic location system comprising a plurality of wave transmitters, a plurality of wave receivers, and at least one processor coupled to the plurality of wave transmitters and the plurality of wave receivers, the method comprising: controlling, by the at least one processor, each wave transmitter of the plurality of wave transmitters sequentially to transmit at least one wave; receiving, by the at least one processor, data descriptive of at least one reflection of the at least one wave; calculating at least one direction of arrival (DoA) of the at least one reflection based on the data descriptive of the at least one reflection; and calculating at least one time of flight (ToF) of the at least one wave and the at least one reflection based on the data descriptive of the at least one reflection and data descriptive of the at least one wave.

Example 18 includes the subject matter of Example 17, further comprising transmitting, by each wave transmitter to the at least one processor, data descriptive of any wave the transmitter transmits.

Example 19 includes the subject matter of Example 17 or 18, further comprising controlling the plurality of wave receivers to monitor for the at least one wave transmitted by each wave transmitter.

Example 20 includes the subject matter of Example 19, further comprising transmitting, by each receiver to the at least one processor, data descriptive of any reflection received by the receiver.

Example 21 includes the subject matter of Example 19 or 20, wherein controlling the plurality of wave receivers includes controlling a plurality of wave receivers arranged in a phased-array configuration.

Example 22 includes the subject matter of Example 21, wherein controlling the plurality of wave receivers arranged in the phased-array configuration includes controlling a phased-array configuration that is linear and that includes at least one of four receivers and eight receivers.

Example 23 includes the subject matter of Example 21 or 22, wherein controlling the plurality of wave receivers arranged in the phased-array configuration includes controlling a phased-array configuration that is two-dimensional and includes at least one of a 4×4 receiver configuration and an 8×8 receiver configuration.

Example 24 includes the subject matter of any of Examples 21 through 23, wherein controlling the plurality of wave receivers arranged in the phased-array configuration includes controlling a phased-array configuration in which two or more wave receivers of the plurality of wave receivers form an axis that is perpendicular to an axis formed by two or more other wave receivers of the plurality of wave receivers.

Example 25 includes the subject matter of any of Examples 17 through 24, wherein controlling each wave transmitter includes controlling each wave transmitter of a plurality of wave transceivers.

Example 26 includes the subject matter of any of Examples 17 through 25, further comprising controlling each wave transmitter of the plurality of wave transmitters to individually transmit at least one wave according to predefined sequence.

Example 27 includes the subject matter of any of Examples 17 through 26, further comprising calculating at least one distance of an object using the at least one DoA and the at least one ToF.

Example 28 includes the subject matter of Example 27, further comprising calculating the at least one distance at least in part by calculating a plurality of measurements and processing the plurality of measurements to determine the at least one distance.

Example 29 includes the subject matter of Example 27 or 28, further comprising refining the at least one distance using a measurement calculated from data descriptive of at least one wave other than the at least one wave and the at least one reflection.

Example 30 includes the subject matter of any of Examples 27 through 29, further comprising transmitting data descriptive of the at least one distance to a navigation system via an interface.

Example 31 includes the subject matter of any of Examples 17 through 30, further comprising controlling the plurality of wave transmitters to delay for a period of time between consecutive wave transmissions.

Example 32 includes the subject matter of Example 31, further comprising calculating an amount of change between the at least one distance and the at least one other distance, comparing the amount of change to a threshold, and adjusting the period of time in response to the amount of change transgressing the threshold.

Example 33 is a non-transient computer program product encoded with instructions that when executed by one or more processors cause a process for locating objects to be carried out, the process comprising: controlling, by the at least one processor, each wave transmitter of the plurality of wave transmitters sequentially to transmit at least one wave; receiving, by the at least one processor, data descriptive of at least one reflection of the at least one wave; calculating at least one direction of arrival (DoA) of the at least one reflection based on the data descriptive of the at least one reflection; and calculating at least one time of flight (ToF) of the at least one wave and the at least one reflection based on the data descriptive of the at least one reflection and data descriptive of the at least one wave.

Example 34 includes the subject matter of Example 33, further comprising transmitting, by each wave transmitter to the at least one processor, data descriptive of any wave the transmitter transmits.

Example 35 includes the subject matter of Example 33 or 34, further comprising controlling the plurality of wave receivers to monitor for the at least one wave transmitted by each wave transmitter.

Example 36 includes the subject matter of Example 35, further comprising transmitting, by each receiver to the at least one processor, data descriptive of any reflection received by the receiver.

Example 37 includes the subject matter of Example 35 or 36, wherein controlling the plurality of wave receivers includes controlling a plurality of wave receivers arranged in a phased-array configuration.

Example 38 includes the subject matter of Example 37, wherein controlling the plurality of wave receivers arranged in the phased-array configuration includes controlling a phased-array configuration that is linear and that includes at least one of four receivers and eight receivers.

Example 39 includes the subject matter of Example 37 or 38, wherein controlling the plurality of wave receivers arranged in the phased-array configuration includes controlling a phased-array configuration that is two-dimensional and includes at least one of a 4×4 receiver configuration and an 8×8 receiver configuration.

Example 40 includes the subject matter of any of Examples 37 through 39, wherein controlling the plurality of wave receivers arranged in the phased-array configuration includes controlling a phased-array configuration in which two or more wave receivers of the plurality of wave receivers form an axis that is perpendicular to an axis formed by two or more other wave receivers of the plurality of wave receivers.

Example 41 includes the subject matter of any of Examples 33 through 40, wherein controlling each wave transmitter includes controlling each wave transmitter of a plurality of wave transceivers.

Example 42 includes the subject matter of any of Examples 33 through 41, further comprising controlling each wave transmitter of the plurality of wave transmitters to individually transmit at least one wave according to predefined sequence.

Example 43 includes the subject matter of any of Examples 33 through 42, further comprising calculating at least one distance of an object using the at least one DoA and the at least one ToF.

Example 44 includes the subject matter of Examples 43, further comprising calculating the at least one distance at least in part by calculating a plurality of measurements and processing the plurality of measurements to determine the at least one distance.

Example 45 includes the subject matter of Example 43 or 44, further comprising refining the at least one distance using a measurement calculated from data descriptive of at least one wave other than the at least one wave and the at least one reflection.

Example 46 includes the subject matter of any of Examples 43 through 45, further comprising transmitting data descriptive of the at least one distance to a navigation system via an interface.

Example 47 includes the subject matter of any of Examples 33 through 46, further comprising controlling the plurality of wave transmitters to delay for a period of time between consecutive wave transmissions.

Example 48 includes the subject matter of Example 47, further comprising calculating an amount of change between the at least one distance and the at least one other distance, comparing the amount of change to a threshold, and adjusting the period of time in response to the amount of change transgressing the threshold.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. An ultrasonic location system comprising:
a plurality of wave transmitters;
a plurality of wave receivers; and
at least one processor coupled to the plurality of wave transmitters and the plurality of wave receivers and configured to control each wave transmitter of the plurality of wave transmitters sequentially to transmit at least one wave, to receive data descriptive of at least one reflection of the at least one wave, to calculate at least one direction of arrival (DoA) of the at least one reflection based on the data descriptive of the at least one reflection, and to calculate at least one time of flight (ToF) of the at least one wave and the at least one reflection based on the data descriptive of the at least one reflection and data descriptive of the at least one wave.

2. The ultrasonic location system of claim 1, wherein each transmitter of the plurality of transmitters is configured to transmit, to the at least one processor, data descriptive of any wave the transmitter transmits.

3. The ultrasonic location system of claim 1, wherein the plurality of wave receivers is arranged in a phased-array configuration.

4. The ultrasonic location system of claim 3, wherein the phased-array configuration is linear and includes at least one of four receivers and eight receivers.

5. The ultrasonic location system of claim 3, wherein the phased-array configuration is two-dimensional and includes at least one of a 4×4 receiver configuration and an 8×8 receiver configuration.

6. The ultrasonic location system of claim 1, wherein two or more wave receivers of the plurality of wave receivers form an axis that is perpendicular to an axis formed by two or more other wave receivers of the plurality of wave receivers.

7. The ultrasonic location system of claim 1, wherein the at least one controller is further configured to control the plurality of wave receivers to monitor for the at least one wave transmitted by each wave transmitter.

8. The ultrasonic location system of claim 7, wherein each receiver of the plurality of receivers is configured to transmit, to the at least one processor, data descriptive of any reflection received by the receiver.

9. The ultrasonic location system of claim 1, wherein the plurality of wave receivers and the plurality of wave transmitters are arranged into a plurality of wave transceivers.

10. The ultrasonic location system of claim 1, wherein the at least one processor is further configured to control each wave transmitter of the plurality of wave transmitters to individually transmit at least one wave according to predefined sequence.

11. The ultrasonic location system of claim 1, wherein at least one processor is further configured to calculate at least one distance of an object using the at least one DoA and the at least one ToF.

12. The ultrasonic location system of claim 11, wherein the at least one processor is configured to calculate the at least one distance at least in part by calculating a plurality of measurements and processing the plurality of measurements to determine the at least one distance.

13. The ultrasonic location system of claim 11, wherein the at least one processor is further configured to refine the at least one distance using a measurement calculated from data descriptive of at least one wave other than the at least one wave and the at least one reflection.

14. The ultrasonic location system of claim 11, further comprising an interface coupled to a navigation system, wherein the at least processor is further configured to transmit data descriptive of the at least one distance to the navigation system via the interface.

15. The ultrasonic location system of claim 1, wherein the at least one processor is further configured to control the plurality of wave transmitters to delay for a period of time between consecutive wave transmissions.

16. The ultrasonic location system of claim 15, wherein the at least one processor is further configured to calculate an amount of change between the at least one distance and the at least one other distance, to compare the amount of change to a threshold, and to adjust the period of time in response to the amount of change transgressing the threshold.

17. A method of locating objects using an ultrasonic location system comprising a plurality of wave transmitters, a plurality of wave receivers, and at least one processor coupled to the plurality of wave transmitters and the plurality of wave receivers, the method comprising:
controlling, by the at least one processor, each wave transmitter of the plurality of wave transmitters sequentially to transmit at least one wave;
receiving, by the at least one processor, data descriptive of at least one reflection of the at least one wave;
calculating at least one direction of arrival (DoA) of the at least one reflection based on the data descriptive of the at least one reflection; and
calculating at least one time of flight (ToF) of the at least one wave and the at least one reflection based on the data descriptive of the at least one reflection and data descriptive of the at least one wave.

18. The method of claim 17, further comprising calculating at least one distance of an object using the at least one DoA and the at least one ToF.

19. The method of claim 18, further comprising calculating the at least one distance at least in part by calculating a plurality of measurements and processing the plurality of measurements to determine the at least one distance.

20. The method of claim 18, further comprising refining the at least one distance using a measurement calculated from data descriptive of at least one wave other than the at least one wave and the at least one reflection.

21. The method of claim 18, further comprising transmitting data descriptive of the at least one distance to a navigation system via an interface.

22. The method of claim 17, further comprising controlling the plurality of wave transmitters to delay for a period of time between consecutive wave transmissions.

23. The method of claim 22, further comprising calculating an amount of change between the at least one distance and the at least one other distance, comparing the amount of change to a threshold, and adjusting the period of time in response to the amount of change transgressing the threshold.

24. A non-transient computer program product encoded with instructions that when executed by one or more processors cause a process for locating objects to be carried out, the process comprising:
controlling, by the at least one processor, each wave transmitter of the plurality of wave transmitters sequentially to transmit at least one wave;
receiving, by the at least one processor, data descriptive of at least one reflection of the at least one wave;
calculating at least one direction of arrival (DoA) of the at least one reflection based on the data descriptive of the at least one reflection; and
calculating at least one time of flight (ToF) of the at least one wave and the at least one reflection based on the data descriptive of the at least one reflection and data descriptive of the at least one wave.

25. The computer program product of claim 24, further comprising calculating at least one distance of an object using the at least one DoA and the at least one ToF.
